(19) United States
(12) Patent Application Publication
(10) Pub. No.: US 2006/0133115 A1
(43) Pub. Date: Jun. 22, 2006

(54) Adaptive blanking of transformer primary-side feedback winding signals

(76) Inventor: Vijay Gangadhar Phadke, Pasig City (PH)

Correspondence Address: HARNESS, DICKEY, & PIERCE, P.L.C, 7700 BONHOMME, STE 400, ST. LOUIS, MO, 63105, US

(21) Appl. No.: 11/315,907

(22) Filed: Dec. 22, 2005

Related U.S. Application Data
(60) Provisional application No. 60/639,093, filed on Dec. 22, 2004.

(51) Int. Cl. H02M 3/335

(52) U.S. Cl. 363/16

(57) ABSTRACT

A method of regulating a power converter using a transformer primary-side feedback winding to provide a feedback signal. The feedback signal is selectively blanked based on a signal indicative of a duty cycle of a switch controlling the converter. The converter is regulated based on the selectively blanked feedback signal. The blanking is dynamically adapted to changes in the switch duty cycle.

### CROSS-REFERENCE TO RELATED APPLICATION

This application claims the benefit of U.S. Provisional Application No. 60/639,093, filed on Dec. 22, 2004. The entire disclosure of the above application is incorporated herein by reference.

### FIELD

The present disclosure relates to power converters and more particularly (but not exclusively) to using a transformer primary-side feedback winding to regulate power converter voltage.

### BACKGROUND

The statements in this section merely provide background information related to the present disclosure and may not constitute prior art.

In many low-power applications such as battery chargers, it is highly desirable to provide good output voltage regulation. Flyback converter topologies which can provide low output power are typically utilized in these applications. A primary-side feedback winding may be used to provide voltage regulation in a flyback converter. However, feedback signals obtained from such windings can include voltage spikes at the signal leading edges. Such spikes may be caused, for example, by leakage inductances between primary and secondary windings of the converter.

A simplified configuration of a conventional flyback converter is indicated generally in FIG. 1 by reference number 20. The converter 20 provides power to a load 22. The converter 20 includes a primary winding 24, a secondary winding 28 and a primary-side flyback feedback winding 32. The feedback winding 32 senses voltage reflected by the secondary winding 28. A peak detection circuit 36 detects peak voltage across the feedback winding 32 which is used by a pulse-width modulator (PWM) 40 to control a switch 44 that switches voltage across the primary winding 24. A diode 48 and a capacitor 52 form a filter for output of the secondary winding 28.

Feedback signals obtained from the feedback winding 32 may include voltage spikes, predominantly at leading edges of the signals. Spikes may be caused, for example, by leakage inductances between the primary winding 24 and secondary winding 28. Voltage spikes can distort peak voltage detection and thus can degrade voltage regulation by the PWM 40. It is desirable to filter such spikes from the feedback in order to obtain an accurate representation of voltage reflected by the secondary winding 28. Various other techniques, for example as described in U.S. Pat. No. 5,008,794 and U.S. Pat. No. 5,517,397, use filtering or blanking of voltage spikes on a feedback winding voltage. This blanking, however, is for a fixed time. These known techniques offer reasonably good voltage sensing, but have poor regulation performance at no load.

### SUMMARY

The present disclosure, in one aspect, is directed to a method of regulating a power converter using a transformer primary-side feedback winding to provide a feedback signal. The feedback signal is selectively blanked based on a signal indicative of a duty cycle of the converter. The converter is regulated based on the selectively blanked feedback signal.

In another aspect, the disclosure is directed to a method of regulating a flyback converter. The converter includes a switch for switching voltage across a primary winding of the converter to regulate power to a load. A transformer primary-side feedback winding is used to provide a feedback signal. A reference voltage is selected to indicate a blanking threshold for blanking a portion of the feedback signal. A voltage signal is varied based on a duration of a pulse of the switch. The feedback signal is blanked while the varied voltage signal exceeds the blanking threshold to filter the feedback signal. The filtered signal is used as feedback as feedback to control the switch.

In another aspect, the disclosure is directed to a feedback control circuit for regulating voltage input to a converter. The converter has a switch that switches voltage across a primary winding of the converter. The circuit includes a primary-side feedback winding configured to produce a feedback signal. A blanking subcircuit is configured to monitor a duration of a pulse of the switch. The blanking subcircuit also is configured to blank a portion of the feedback signal during a blanking time period based on the monitored pulse duration.

In yet another aspect, the disclosure is directed to a feedback control circuit for regulating voltage input to a flyback converter. The converter has a switch that switches voltage across a primary winding of the converter. A primary-side flyback feedback winding is configured to produce a feedback signal. A blanking subcircuit is configured to determine, based on a signal indicative of a duty cycle of the switch, a time during which to blank a portion of the feedback signal. The blanking subcircuit is configured to blank a portion of the feedback signal during the determined time period.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram of a simplified configuration of a conventional flyback converter;

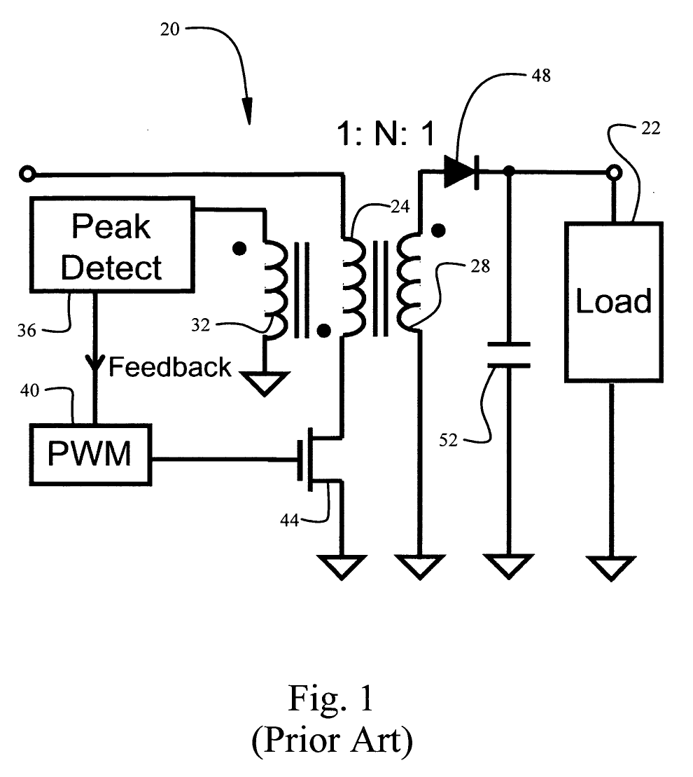

FIG. 2 is a sequence diagram of one implementation, in accordance with one aspect of the disclosure, of a method of regulating a power converter having a transformer primary-side feedback winding;

FIG. 3 is a block/circuit diagram of a feedback control circuit for regulating voltage input to a converter in accordance with one aspect of the disclosure;

FIG. 4 is a timing diagram of various waveforms of a converter implemented in accordance with one aspect of the disclosure;

FIG. 5 is a schematic of a PWM flyback converter according to one aspect of the present disclosure; and

FIG. 6 is a schematic of a ringing choke converter according to one aspect of the present disclosure.

### DETAILED DESCRIPTION

The following description is merely exemplary in nature and is not intended to limit the present disclosure, application, or uses.

It can be shown that amplitude of spikes, and duration of spikes and ringing, in primary-side feedback winding feedback depend upon load conditions. Accordingly, in some aspects of the disclosure, leading edges of a primary-side flyback winding feedback voltage signal are adaptively blanked. Feedback voltage is selectively filtered such that a time period during which blanking is performed varies in accordance with converter output load. Thus a reflected secondary voltage may be sensed substantially accurately, even though spikes and oscillations may be present in the unfiltered feedback voltage.

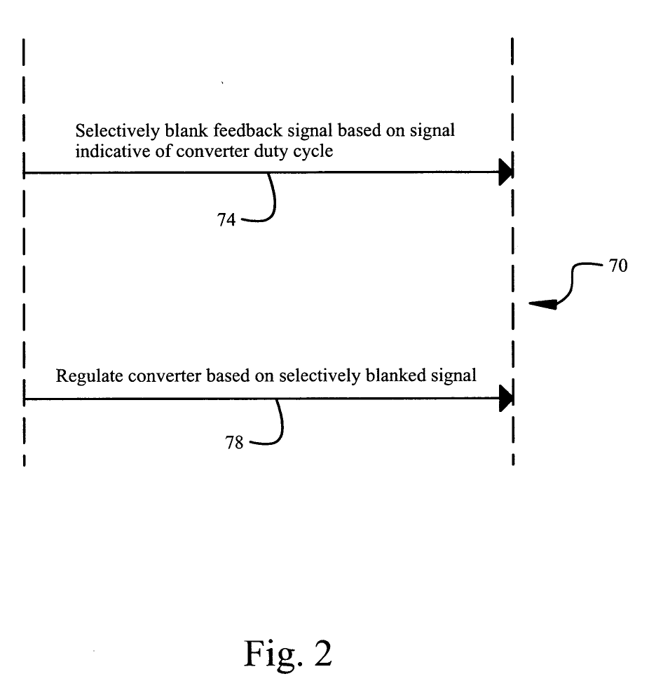

A sequence diagram of one implementation of a method of regulating a power converter having a transformer primary-side feedback winding is indicated generally in FIG. 2 by reference number 70. In operation 74 a feedback signal is selectively blanked based on a signal indicative of a duty cycle of the converter. In operation 78, the converter is regulated based on the selectively blanked feedback signal.

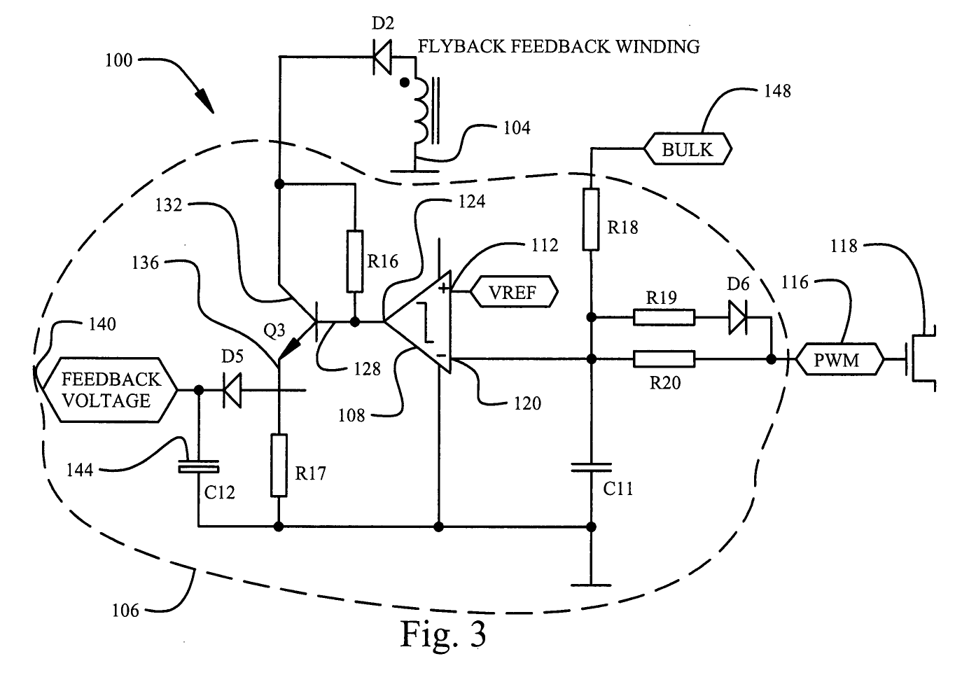

An exemplary configuration of a feedback control circuit for regulating voltage input to a converter is indicated generally in FIG. 3 by reference number 100. The circuit 100 includes a flyback feedback winding 104 that senses voltage reflected by a flyback converter secondary winding (not shown). The feedback winding 104 is configured to provide voltage feedback for a pulse-width modulator (PWM) 116. The PWM 116 modulates the voltage signal of a switch 118 that is input to a primary winding (not shown) of the converter. Based on a duty cycle of the PWM 116 and switch 118, a blanking subcircuit 106 determines a time during which to blank a portion of the feedback signal. The blanking subcircuit 106 blanks a portion of the feedback signal during the determined time period (referred to as the “blanking time period”, “blanking time”, and/or “blanking period”).

The circuit 100 shall now be described in greater detail. A comparator 108 receives a preselected reference voltage VREF at a non-inverting pin 112 and a signal from the PWM 116 at an inverting pin 120. An output pin 124 of the comparator 108 is connected with a base 128 of a transistor Q3. The collector 132 of the transistor Q3 is connected with the flyback feedback winding 104 through a rectifying diode D2. The transistor emitter 136 is connected with a feedback voltage output terminal 140 through a diode D5. One side 144 of a capacitor C12 is connected between the feedback output terminal 140 and diode D5. The comparator inverting pin 120 is connected between a line voltage 148 and a capacitor C11. A resistor R18 is connected between the line voltage 148 and a resistor R19 in series with a diode D6. The resistor R9 and diode D6 are connected in parallel with a resistor R20 and between the PWM 116 and the inverting pin 120.

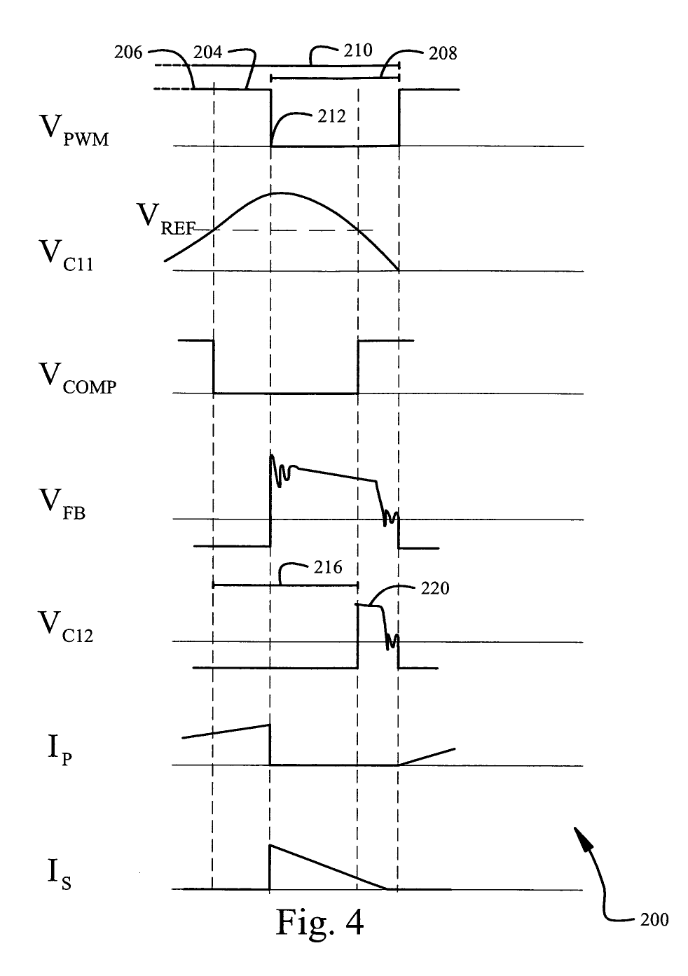

A timing diagram of various waveforms that may be produced during operation of the circuit 100 is indicated generally in FIG. 4 by reference number 200. A pulse waveform V_{PWM} is produced by the PWM 116. A pulse 204 having a pulse width (also called pulse duration) 206 is partially shown, followed by an “off” period 208. As known in the art, a duty cycle is defined by the ratio of the pulse duration 206 to the sum of the pulse duration 206 and “off” period 208. The sum defines a pulse period 210.

A waveform V_{C11} represents voltage across the capacitor C11. A waveform V_{COMP} is produced at the comparator output pin 124. A feedback voltage waveform V_{FB} is produced by the primary-side flyback winding 104. A voltage V_{C12} is produced across the capacitor C12. A primary current I_{P} through the converter primary winding and a secondary current Iₛ through the secondary winding are shown for reference.

When the circuit 100 is in operation, the PWM signal is fed into the inverting pin 120 of the comparator 108 through the resistor R20. For discontinuous mode flyback converters, switching duty cycle increases with load. Continuous mode flyback converters also are discontinuous in nature up to various load levels, which, e.g., could be as high as sixty percent load, and thus also exhibit the foregoing characteristic. The PWM pulse voltage V_{PWM} charges the capacitor C11 during the pulse duration 206. The capacitor C11 is charged relative to the threshold level set by voltage VREF. At high load conditions and during a conduction period of the converter primary switch, voltage V_{C11} of the capacitor C11 can exceed VREF after some time, causing the comparator output V_{COMP} to go low. The amount by which the charge on the capacitor C11 exceeds the VREF level depends upon the V_{PWM} pulse width 206. When V_{PWM} goes low at a time 212, at the end of a switching cycle, the signal information is kept in PWM 116 memory for a pre-determined time as the capacitor C11 is discharged through the resistor R19 and rectifier D6. Discharge time of the capacitor C11 is directly proportional to blanking time. Charge on the capacitor C11, and thus blanking time of the flyback pulse, increases with PWM on-time. As long as the output V_{COMP} of comparator 108 remains low, the flyback voltage V_{FB} is not allowed to charge the capacitor C12.

After a blanking period 216, the capacitor voltage V_{c11} falls below the VREF level. The comparator 108 releases the control input V_{COMP} at the base 128 of the transistor Q3. Thereafter, a flat top portion 220 of the flyback reflected voltage V_{FB} charges the capacitor C12. The blanking period 216 may vary in accordance with variation (if any) in V_{PWM} pulse duration and duty cycle.

At no-load condition and/or in light load conditions, the V_{PWM} pulse widths are very short. A short pulse width may not provide enough time in which to charge the capacitor C11 up to the VREF threshold. Accordingly, the output V_{COMP} of the comparator 108 does not go low. At such times the flyback voltage V_{FB}, as coupled to and rectified by the diode D2, directly charges the filter capacitor C12 through the transistor Q3 and rectifier D5. Various known circuit configurations could be used to eliminate error that might be caused by voltage loss in the transistor Q3 and diode D5. At no-load and/or light load conditions, any spikes on the flyback voltage V_{FB} of the feedback winding 104 are negligible. Therefore the voltage V_{C12} on the capacitor C12 represents a substantially accurate reflected voltage.

The resistor R18 is optional and may be used as feed-forward to compensate for variation in the PWM pulse width due to input line 148 variation. Resistor R18 may also be useful when it is desirable to pre-charge the capacitor C11. Pre-charging C11 may be desirable, for example, when a duty cycle at a relatively higher line voltage is lower than at a relatively lower line voltage for the same output load. Such a condition can be compensated for by pre-charging the capacitor C11 through the resistor R18 to a predefined DC level. In such manner, a relatively low duty cycle at a high line voltage and a relatively high duty cycle at a low line voltage can produce substantially the same blanking time for a given output load.

Implementations of the foregoing adaptive blanking methods and systems can be used to control the blanking period so as to ensure that a reflected secondary voltage is accurately sensed by a voltage regulating circuit. Filtered reflected voltage, which in the circuit 100 is stored on capacitor C12, may be used to close a voltage regulation control loop of the converter.

Various circuits and systems, digital and/or analog, are contemplated whereby adaptive blanking could be implemented. It will be evident to those knowledgeable in the art that the methods and systems described above could be implemented in a variety of ways. Although the foregoing circuits and methods are described with reference to PWM control, other or additional forms of control could be used. Implementations the foregoing systems and methods are contemplated in relation to various power converter types, including but not limited to discontinuous-mode and/or continuous-mode converters. Systems and methods in accordance with the disclosure also could be implemented in connection with ringing choke converters, fixed-frequency and/or variable-frequency critically discontinuous mode converters.

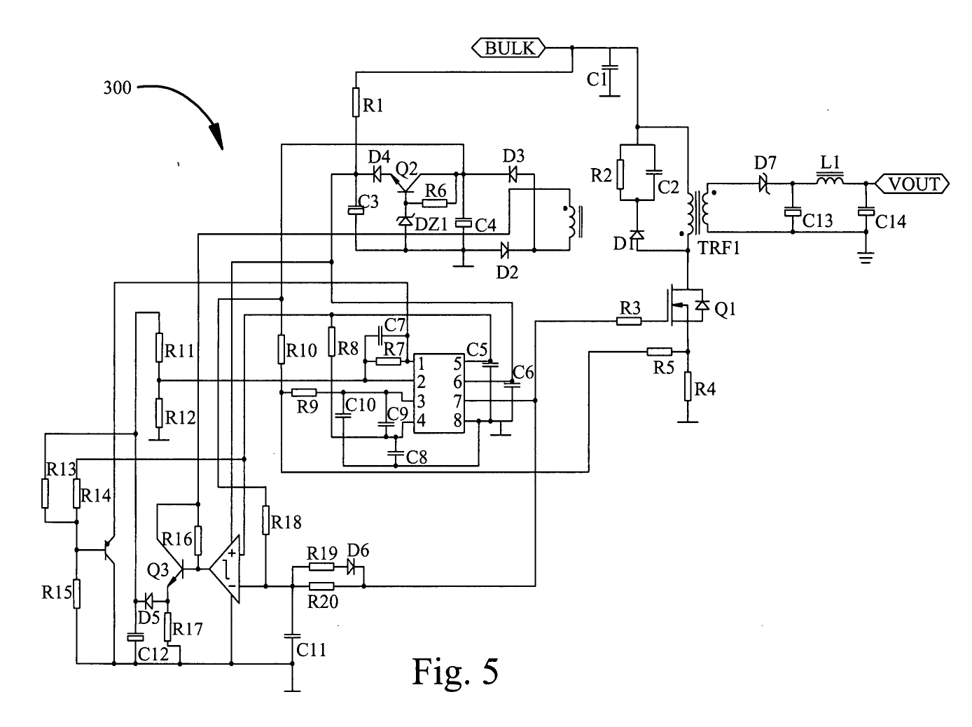

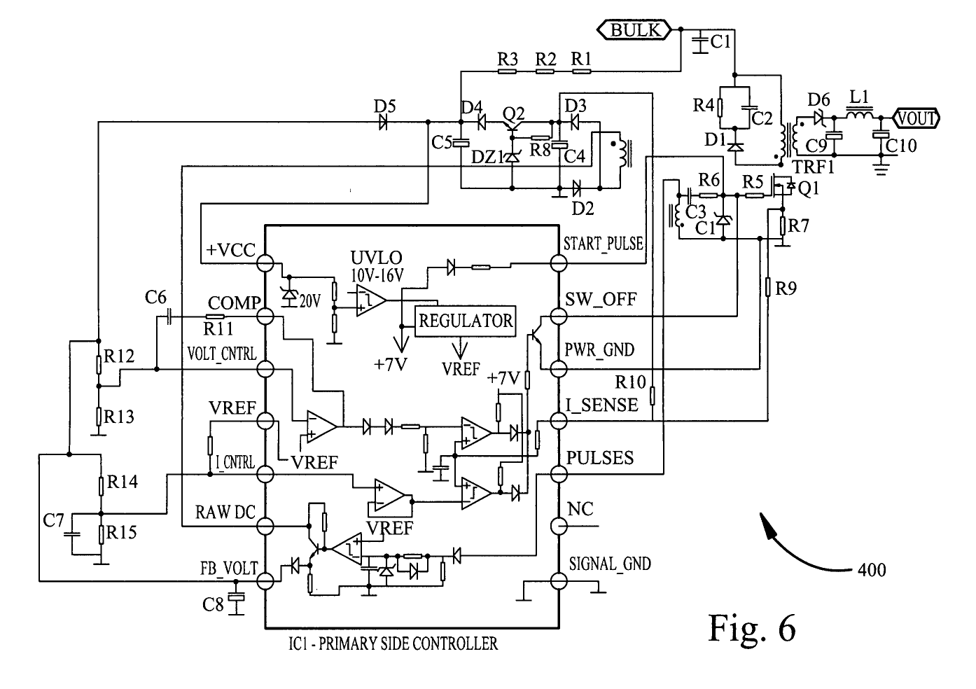

An exemplary PWM flyback converter that includes primary-side adaptive blanking is indicated generally in FIG. 5 by reference number 300. An exemplary ringing choke converter that includes primary-side adaptive blanking is indicated generally in FIG. 6 by reference number 400.

Various implementations of the foregoing methods and systems can be used to achieve tight voltage control of flyback converters. No secondary-side feedback is required, and so opto-couplers are not required. The foregoing systems and methods can be implemented at lower cost and using fewer parts compared to other systems and methods. Accordingly, superior output voltage regulation can be achieved economically.

What is claimed is:

1. A method of regulating a power converter using a transformer primary-side feedback winding to provide a feedback signal, the method comprising:
selectively blanking the feedback signal based on a signal indicative of a duty cycle of the converter; and
regulating the converter based on the selectively blanked feedback signal.

2. The method of claim 1 further comprising blanking a portion of the feedback signal that includes a leading edge of the feedback signal.

3. The method of claim 1 further comprising dynamically adapting a time for blanking the feedback signal to a change in the duty cycle.

4. The method of claim 1 further comprising dynamically adapting a time for blanking the feedback signal to a change in an output load of the converter.

5. The method of claim 1 wherein the signal indicative of a duty cycle of the converter includes a voltage, and the selective blanking is performed while the voltage exceeds a predetermined threshold.

6. A method for selectively blanking the voltage spike on a flyback feedback winding voltage used for primary side feedback regulation in a power converter having a primary and secondary winding for enabling a sensing on the primary winding side of the converter of a true reflected voltage of said secondary winding comprising:
receiving of said flyback feedback winding voltage; and
providing a blanking period for selectively filtering said flyback feedback winding voltage, said blanking period increasing with the output voltage of said converter for ensuring that any such voltage spikes on the primary and secondary winding settle; so as to provide a sensing on the primary side of the converter of a true reflected voltage of said secondary winding.

7. The method of claim 6 wherein the blanking period is provided based on a switching pulse width of the converter.

8. A method of regulating a flyback converter including a switch for switching voltage across a primary winding of the converter to regulate power to a load, the converter further including a transformer primary-side feedback winding to provide a feedback signal, the method comprising:
selecting a reference voltage to indicate a blanking threshold for blanking a portion of the feedback signal;
varying a voltage signal based on a duration of a pulse of the switch;
blanking the feedback signal while the varied voltage signal exceeds the blanking threshold to filter the feedback signal; and
using the filtered signal as feedback to control the switch.

9. The method of claim 8, further comprising selecting the reference voltage based on a duty cycle of the switch.

10. The method of claim 8, further comprising presetting the voltage signal to a DC value based on a line voltage to the converter.

11. The method of claim 8, further comprising dynamically adapting the blanking to a change in the load.

12. A feedback control circuit for regulating voltage input to a converter having a switch that switches voltage across a primary winding of the converter, the circuit comprising:
a primary-side feedback winding configured to produce a feedback signal; and
a blanking subcircuit configured to:
monitor a duration of a pulse of the switch; and
blank a portion of the feedback signal during a blanking time period based on the monitored pulse duration.

13. The circuit of claim 12 wherein the blanking subcircuit is further configured to blank a portion of the feedback signal that includes a leading edge.

14. The circuit of claim 12 wherein the blanking subcircuit is configured to compare a signal indicative of the pulse duration to a threshold value to determine whether to blank a portion of the feedback signal.

15. The circuit of claim 12 wherein the blanking subcircuit is configured to dynamically adapt the blanking time period to a change in duty cycle of the switch.

16. The circuit of claim 12 wherein the blanking subcircuit is configured to dynamically adapt the blanking time period to a change in switch pulse duration.

17. A converter comprising the circuit of claim 12.

18. A feedback control circuit for regulating voltage input to a flyback converter having a switch that switches voltage across a primary winding of the converter, the circuit comprising:
a primary-side flyback feedback winding configured to produce a feedback signal; and
a blanking subcircuit configured to:
determine, based on a signal indicative of a duty cycle of the switch, a time during which to blank a portion of the feedback signal; and
blank a portion of the feedback signal during the determined time period.

19. A converter comprising the circuit of claim 18.

20. The circuit of claim 18 wherein the blanking subcircuit is configured to dynamically adapt the determined time period to a change in a load of the converter.
